(19) United States
(12) Patent Application Publication
(10) Pub. No.: US 2026/0164447 A1
(43) Pub. Date: Jun. 11, 2026

(54) Method and Apparatus for Frequency Domain Resource Assignment, and Device

(71) Applicants: CHINA MOBILE COMMUNICATION CO., LTD RESEARCH INSTITUTE, Beijing (CN); CHINA MOBILE COMMUNICATIONS GROUP CO., LTD., Beijing (CN)

(72) Inventors: Tuo Yang, Beijing (CN); Lijie Hu, Beijing (CN)

(21) Appl. No.: 18/706,860

(22) PCT Filed: Nov. 14, 2022
(86) PCT No.: PCT/CN2022/131738

§ 371 Date: May 2, 2024

(30) Foreign Application Priority Data
Nov. 12, 2021 (CN) 202111342504.8

(51) Int. Cl. H04W 72/232; H04W 72/0453

(52) U.S. Cl. CPC H04W 72/232; H04W 72/0453

(57) ABSTRACT

A method for frequency domain resource assignment, performed by a network side device, includes: sending downlink control information (DCI) to a terminal, in which the DCI is used to indicate the frequency domain resource assignment for physical shared channel, and frequency domain resources of the physical shared channel are located within one or more frequency domain resource ranges.

### CROSS REFERENCE TO RELATED APPLICATIONS

This application is a US national phase of International Application No. PCT/CN2022/131738, filed on Nov. 14, 2022, which claims priority to Chinese patent application No. 202111342504.8, filed on Nov. 12, 2021, the entire content of which is incorporated herein by reference.

### TECHNICAL FIELD

The disclosure relates to a field of communication technology, in particular to methods for frequency domain resource assignment, apparatuses frequency domain resource assignment and related devices.

### BACKGROUND

Currently, there are many discontinuous spectrums with smaller bandwidths in New Radio (NR). According to the previous spectrum usage, a terminal may perform carrier aggregation of these carriers, and a Transport Block (TB) may be transmitted within one carrier.

### SUMMARY

According to a first aspect of embodiments of the disclosure, a method for frequency domain resource assignment, applied to a network side device, is provided. The method includes:
sending downlink control information (DCI) to a terminal, in which the DCI is used to indicate frequency domain resource assignment for physical shared channel, and frequency domain resource of the physical shared channel are located within one or more frequency domain resource ranges.

According to a second aspect of embodiments of the disclosure, a method for frequency domain resource assignment, applied to a terminal, is provided. The method includes:
receiving downlink control information (DCI) sent by a network side device, in which the DCI is used to indicate frequency domain resource assignment for physical shared channel, and frequency domain resources of the physical shared channel are located within one or more frequency domain resource ranges.

According to a third aspect of embodiments of the disclosure, a communication device is provided, which includes a processor and a memory having a computer program stored thereon. When the computer program is executed by the processor, the processor is configured to:
send downlink control information (DCI) to a terminal, in which the DCI is used to indicate frequency domain resource assignment for physical shared channel, and frequency domain resource of the physical shared channel are located within one or more frequency domain resource ranges.

### BRIEF DESCRIPTION OF THE DRAWINGS

FIG. 1 is a flowchart illustrating a method for frequency domain resource assignment according to an embodiment of the disclosure.

FIG. 2 is a schematic diagram illustrating a spectrum of a first type of bandwidth according to an embodiment of the disclosure.

FIG. 3 is a schematic diagram illustrating a spectrum of a second type of bandwidth according to an embodiment of the disclosure.

FIG. 4 is a schematic diagram illustrating a spectrum of a third type of bandwidth according to an embodiment of the disclosure.

FIG. 5 is a schematic diagram illustrating modules of an apparatus for frequency domain resource assignment according to an embodiment of the disclosure.

### DETAILED DESCRIPTION

Embodiments of the disclosure will be described in detail below with reference to the accompanying drawings. Although the embodiments of the disclosure are shown in the accompanying drawings, it is understandable that the disclosure may be realized in various forms instead of being limited by embodiments set forth herein. Instead, these embodiments are provided to enable a more thorough understanding of the disclosure and to convey the scope of the disclosure completely to those skilled in the art.

Currently, there are many discontinuous spectrums with smaller bandwidths in New Radio (NR). According to the previous spectrum usage, a terminal can only perform carrier aggregation of these carriers, and a Transport Block (TB) can still only be transmitted within one carrier. Since the bandwidth of each carrier is very small and cannot support a larger TB size, for a service packet, the base station can only split it into multiple small TBs for transmission, and multiple physical downlink control channels (PDCCHs) are required for scheduling respectively, resulting in relatively large PDCCH overhead. The throughput of carrier usage is limited by the fact that the bandwidth of each carrier is very small, and also by the inability to support a PDCCH with a larger aggregation level.

The technical problem to be solved by the disclosure is to provide methods and apparatuses for frequency domain resource assignment and related devices, to realize scheduling for multiple different frequency domain resources through one downlink control information (DCI), improve a throughput of carrier usage, and reduce an overhead of a physical downlink control channel (PDCCH).

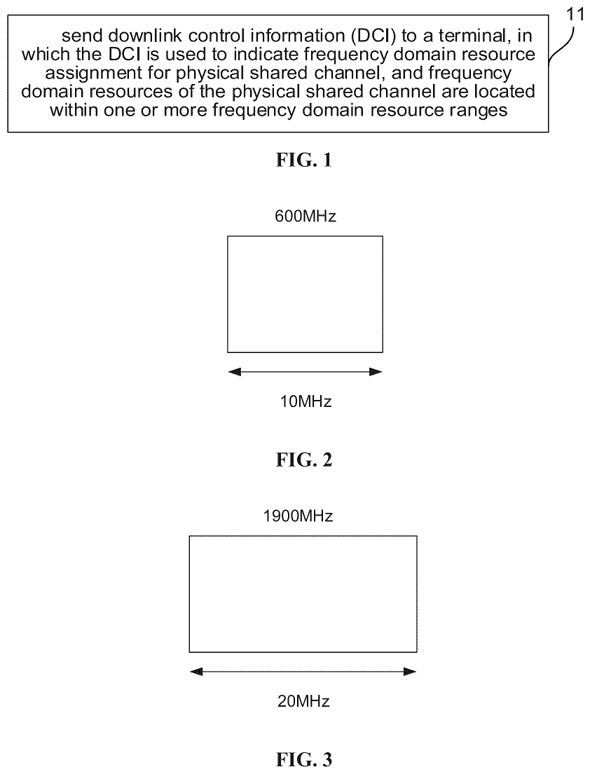

As illustrated in FIG. 1, embodiments of the disclosure provide a method for frequency domain resource assignment, which is applied to a network side device. The method includes a block 11.

At block 11, downlink control information (DCI) is sent to a terminal, in which the DCI is used to indicate frequency domain resource assignment for physical shared channel, and frequency domain resources of the physical shared channel are located within one or more frequency domain resource ranges.

In this embodiment, the DCI may be sent to the terminal. The DCI is used to indicate the frequency domain resource assignment for the physical shared channel, and the frequency domain resources of the physical shared channel are located within one or more frequency domain resource ranges. The scheduling for multiple different frequency domain resource ranges may be realized using one DCI, to improve the throughput of carrier usage and reduce the overhead of a physical downlink control channel (PDCCH).

In an optional embodiment of the disclosure, in block 11, the DCI includes a first information field and a second information field.

The first information field is used to indicate index(s) of the one or more frequency domain resource ranges where the frequency domain resources of the physical shared channel are located in.

The second information field is used to indicate the frequency domain resource assignment within a frequency domain resource range.

The frequency domain resource range is a carrier or a Bandwidth Part (BWP).

In this embodiment, in detail, the second information field is used for indicating the frequency domain resource assignment for Physical Downlink Shared Channel (PDSCH) or Physical Uplink Shared Channel (PUSCH) within one carrier or BWP. The second information field is shared by multiple frequency domain resource ranges. In other words, multiple frequency domain resource ranges all refer to the frequency domain resource assignment indicated by the second information field, which saves the load size of the PDCCH and improves the throughput of the PDCCH.

In an optional embodiment of the disclosure, the first information field uses a bitmap or a codepoint to indicate the index(s) of the one or more frequency domain resource ranges.

In this embodiment, the first information field uses a bitmap or a codepoint to indicate the index(s) of at least one frequency domain resource range where the actually scheduled PDSCH or PUSCH is located in. For example, when there are 5 carriers or BWPs, a 5-bitmap may be used to indicate which carriers or BWPs are scheduled.

When actually scheduling at least two target frequency domain resources, it is also possible that some carriers or BWPs are combined or configured at the base station, and then the combined or configured index is indicated through the first information field.

In an optional embodiment of the disclosure, the frequency domain resource range includes: a first frequency domain resource range with a minimum bandwidth and at least one second frequency domain resource range other than the first frequency domain resource range.

In this embodiment, the first frequency domain resource range is a frequency domain resource range of which the bandwidth is the minimum between at least two frequency domain resource ranges.

In an optional embodiment of the disclosure, a size of bits of the second information field is equal to a size of bits for resource assignment determined based on a bandwidth of the first frequency domain resource range.

In this embodiment, the terminal determines at least one scheduled frequency domain resource range and the frequency domain resource assignment in the at least one scheduled frequency domain resource range based on the first information field and the second information field. The frequency domain resource assignment for the physical channel within each of multiple scheduled frequency domain resource ranges may be all referred to an indication of the second information field. Considering that the bandwidth sizes of the multiple frequency domain resource ranges may be different, the size of the second information field in this embodiment is determined based on the bandwidth of the minimum frequency domain resource range. That is, the size of the second information field is fixed and the load size of the DCI is also fixed, regardless of the index(s) of the scheduled frequency domain resource range(s) indicated by the first information field, thereby simplifying the complexity of receiving, by the terminal, the PDCCH.

In an optional embodiment of the disclosure, when the frequency domain resource assignment is type 1 (i.e., continuous resource assignment), a start resource block (RB) of the second frequency domain resource range corresponding to a resource indication value (RIV) included in the second information field is:

$$R {B}_{start} = 0 , K , 2 \cdot K , … , ( {N}_{min}^{s i z e} - 1 ) \cdot K ;$$

a number of RBs that are consecutively assigned is L_{RBs}=K, 2·K, . . . ,

$${N}_{min}^{s i z e} \cdot K ;$$

where,

$${N}_{min}^{s i z e}$$

represents a bandwidth size of the first frequency domain resource range or a number of physical resource blocks (PRBs); and
K represents a ratio of a bandwidth of the second frequency domain resource range to a bandwidth of the first frequency domain resource range, e.g.,

$$K \leq ⌊ {N}_{o t h e r , i}^{s i z e} / {N}_{min}^{s i z e} ⌋ .$$

In this embodiment, the scheduled frequency domain resource range(s) indicated in the first information field includes(include) a second frequency domain resource range. For the second frequency domain resource range, a frequency domain resource position occupied by a scheduled PDSCH or PUSCH within the second frequency domain resource range is determined using the above method.

When the scheduled frequency domain resource range(s) indicated in the first information field includes(include) the first frequency domain resource range, for the first frequency domain resource range, the frequency domain resource position occupied by a scheduled PDSCH or PUSCH within the first frequency domain resource range is determined based on a relevant method.

In an optional embodiment of the disclosure, when the frequency domain resource assignment is type 0 (i.e., discontinuous resource assignment), bits of the second information field correspond to resource block groups (RBGs) of the second frequency domain resource range, in which,
a size of a first RBG is

$$R B {G}_{0}^{s i z e} = P * K - {N}_{other , i}^{start} mod P * K ;$$

if

$$( {N}_{other , i}^{start} + {N}_{o t h e r , i}^{s i z e} ) mod P * K > 0 ,$$

a size of a last RBG is

$$RB {G}_{last}^{s i z e} = ( {N}_{other , i}^{start} + {N}_{o t h e r , i}^{s i z e} ) mod P * K ,$$

otherwise, the size of the last RBG is P*K, and a size of each remaining RBG is P*K;
where P represents a size of RBG of the first frequency domain resource range, K represents a ratio of a bandwidth of the second frequency domain resource range to a bandwidth of the first frequency domain resource range;

$${N}_{other , i}^{start}$$

represents a resource starting position of the second frequency domain resource range, and

$${N}_{o t h e r , i}^{s i z e}$$

represents a bandwidth size of the second frequency domain resource range or a number of PRBs.

In this embodiment, the scheduled frequency domain resource range(s) indicated in the first information field includes(include) a second frequency domain resource range. For the second frequency domain resource range, the frequency domain resource position occupied by a scheduled PDSCH or PUSCH within the second frequency domain resource range is determined by the method described above.

When the scheduled frequency domain resource range(s) indicated in the first information field includes(include) a first frequency domain resource range, for the first frequency domain resource range, the frequency domain resource position occupied by a scheduled PDSCH or PUSCH within the first frequency domain resource range is determined based on a preset method.

As illustrated in FIGS. 2-4, currently, there are many discontinuous spectrums with smaller bandwidths in the NR network. FIGS. 2-4 are schematic diagrams illustrating carriers or BWPs with three types of bandwidth respectively. These small carriers or BWPs that are discontinuous may be scheduled by one DCI, so that a PDSCH or PUSCH may be mapped on at least one discontinuous frequency domain resource.

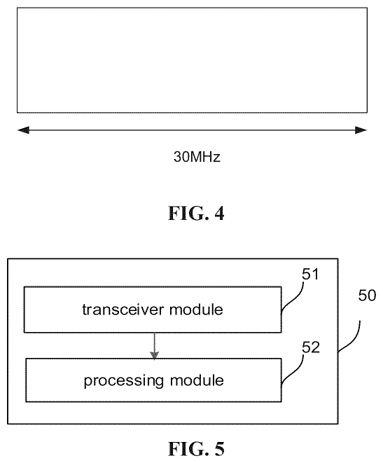

For example, the base station sends the DCI to the terminal. The DCI is used for scheduling the PDSCH or PUSCH. The frequency domain resource range(s) indicated by the first information field of the DCI include at least one of the carriers or BWPs illustrated in FIG. 2, FIG. 3 and FIG. 4. The terminal determines, based on the first information field and the second information field, at least one scheduled frequency domain resource range, a size of bits for the frequency domain resource assignment on the scheduled frequency domain resource ranges and frequency domain resource assignment positions in the scheduled frequency domain resource ranges.

The first frequency domain resource range may be a carrier illustrated in FIG. 2, and the second frequency domain resource range may be a carrier or BWP illustrated in FIG. 3 or 4. The first frequency domain resource range is a frequency domain resource range of which bandwidth is the smallest among the at least one frequency domain resource range. The second information field of the DCI indicates to assign these scheduled frequency domain resources based on the bandwidth of the first frequency domain resource range, i.e., the bandwidth of 10M. That is, the size of bits for the frequency domain resource assignment is equal to the size of bits for the frequency domain resource indication determined based on the first frequency domain resource range.

For the second frequency domain resource range illustrated in FIGS. 3 and 4, if the first information filed indicates that the scheduled frequency domain resource range(s) includes(include) the frequency domain resource range illustrated in FIGS. 3 and/or 4, the frequency domain resources of 20 MHz and 30 MHz need to be mapped based on the size of bits for the frequency domain resource assignment of 10 MHz. When mapping,

### 1) for Resource Assignment Type 1 (i.e., Continuous Resource Assignment)

The terminal explains the RIV indicated by the second information field, in which a start RB corresponding to the RIV is: RBₛₜₐᵣₜ=0, K, 2·K, . . . ,

$$( {N}_{min}^{s i z e} - 1 ) \cdot K ,$$

a number of continuously assigned RBs is L_{RBs}=K, 2·K, . . . ,

$${N}_{min}^{s i z e} \cdot K , where {N}_{min}^{s i z e}$$

where N represents a bandwidth size of the first frequency domain resource range or a number of PRBs, and K represents a ratio of a bandwidth of the second frequency domain resource range to a bandwidth of the first frequency domain resource range, e.g.,

$$K \leq ⌊ {N}_{other , i}^{size} / {N}_{min}^{size} ⌋ or K \leq ⌈ {N}_{other , i}^{size} / {N}_{min}^{size} ⌉ .$$

For example, for the frequency domain resource range illustrated in FIG. 3, K=2; and for the frequency domain resource range illustrated in FIG. 4, K=3.

### 2) for Resource Assignment Type 0 (i.e., Discontinuous Resource Assignment)

The terminal explains the bitmap indicated by the second information field.

Bits of the second information field correspond to RBGs of the second frequency domain resource range, in which, a size of a first RBG is

$$R B {G}_{0}^{size} = P * K - {N}_{other , i}^{start} mod P * K ;$$

if

$$( {N}_{other , i}^{start} + {N}_{other , i}^{size} ) mod P * K > 0 ,$$

a size of a last RBG is

$$R B {G}_{last}^{size} = ( {N}_{other , i}^{start} + {N}_{other , i}^{size} ) mod P * K ,$$

otherwise, the size of the last RBG is P*K, and a size of remaining RBGs is P*K;
where P represents a size of a RBG of the first frequency domain resource range, K represents a ratio of a bandwidth of the second frequency domain resource range to a bandwidth of the first frequency domain resource range, e.g.,

$$K \leq ⌊ {N}_{other , i}^{size} / {N}_{min}^{size} ⌋ or K \leq ⌈ {N}_{other , i}^{size} / {N}_{min}^{size} ⌉ ; {N}_{other , i}^{start}$$

represents a resource starting position of the second frequency domain resource range, and N_{other,i}^{size} represents a bandwidth size of the second frequency domain resource range or a number of PRBs.

For example, for the frequency domain resource range illustrated in FIG. 3, K=2; and for the frequency domain resource range illustrated in FIG. 4, K=3.

In this way, the throughput may be improved by using multiple carriers, a TB packet may be mapped on the discontinuous frequency domain resources, the complexity of processing multiple TB packets by the terminal may be reduced, and the addition of a new PDCCH may be avoided. In addition, the PUSCH sent by the terminal to the base station may be mapped on the same frequency domain resource as the PDSCH.

In above embodiments of the disclosure, the DCI is sent to the terminal. The DCI is used to indicate the frequency domain resource assignment for physical shared channel, and the frequency domain resources of the physical shared channel are located within one or more frequency domain resource ranges. The amount of DCI may be reduced to reduce network side signaling overhead while realizing flexible scheduling of single carrier/multi carriers/frequency domain resources/BWPs, to realize the mapping of a TB packet on discontinuous frequency domain resources, and reduce the complexity of the terminal in handling multiple TB packets. Through the definitions of the first frequency domain resource range and the second frequency domain resource range, the size of the second information field may be determined, to reduce the number of load sizes of different DCI and to reduce the complexity of detecting the PDCCH at the terminal.

Embodiments of the disclosure also provide a method for frequency domain resource assignment, which is applied to a terminal. The method includes:
receiving DCI sent by a network side device, in which the DCI is used to indicate frequency domain resource assignment for physical shared channel, and frequency domain resources of the physical shared channel are located within one or more frequency domain resource ranges.

In some examples, the DCI includes a first information field and a second information field;
the first information field is used to indicate index(s) of the one or more frequency domain resource ranges where the frequency domain resources of the physical shared channel are located in; and
the second information field is used to indicate frequency domain resource assignment within a frequency domain resource range.

In some examples, the first information field uses a bitmap or a codepoint to indicate the terminal the index(s) of the one or more scheduled frequency domain resource ranges.

In some examples, the frequency domain resource range(s) includes(include): a first frequency domain resource range with a minimum bandwidth and at least one second frequency domain resource range other than the first frequency domain resource range.

In some examples, a size of bits of the second information field is equal to a size of bits of resource assignment determined based on a bandwidth of the first frequency domain resource range.

In some examples, when the frequency domain resource assignment is type 1, a start RB of the second frequency domain resource range corresponding to a RIV included in the second information field is:

$$R {B}_{start} = 0 , K , 2 \cdot K , ... , ( {N}_{min}^{s i z e} - 1 ) \cdot K ;$$

a number of RBs that are continuously assigned is L_{RBs}=K, 2·K, . . . ,

$${N}_{min}^{s i z e} \cdot K ;$$

where,

$${N}_{min}^{size}$$

represents a bandwidth size of the first frequency domain resource range or a number of PRBs; and
K represents a ratio of a bandwidth of the second frequency domain resource range to a bandwidth of the first frequency domain resource range.

In some examples, when the frequency domain resource assignment is type 0, bits of the second information field correspond to RBGs of the second frequency domain resource range, in which
a size of a first RBG is

$$R B {G}_{0}^{s i z e} = P * K - {N}_{other , i}^{start} mod P * K ;$$

if

$$( {N}_{other , i}^{start} + {N}_{other , i}^{s i z e} ) mod P * K > 0 ,$$

a size of a last RBG is

$$R B {G}_{last}^{s i z e} = ( {N}_{other , i}^{start} + {N}_{o t h e r , i}^{s i z e} ) mod P * K ,$$

otherwise, the size of the last RBG is P*K, and a size of remaining RBGs is P*K;
where P represents a size of a RBG of the first frequency domain resource range, K represents a ratio of a bandwidth of the second frequency domain resource range to a bandwidth of the first frequency domain resource range;

$${N}_{other , i}^{start}$$

represents a resource starting position of the second frequency domain resource range, and

$${N}_{other , i}^{size}$$

represents a bandwidth size of the second frequency domain resource range or a number of PRBs.

It is noteworthy that the method applied to the terminal is corresponding to the above methods applied to the network side device, and all the implementations of realizing the above methods applied to the network side device are applicable to the method applied to the terminal and may achieve the same technical effects.

As illustrated in FIG. 5, embodiments of the disclosure provide an apparatus 50 for frequency domain resource assignment which is applied to a network side device. The apparatus includes:
a transceiver module 51, configured to send DCI to a terminal, in which the DCI is used to indicate frequency domain resource assignment for physical shared channel, and frequency domain resources of the physical shared channel are located within one or more frequency domain resource ranges.

In some examples, the DCI includes a first information field and a second information field;
the first information field is used to indicate index(s) of the one or more frequency domain resource ranges where the frequency domain resources of the physical shared channel are located in; and
the second information field is used to indicate frequency domain resource assignment within a frequency domain resource range.

In some examples, the first information field uses a bitmap or a codepoint to indicate the index(s) of the one or more frequency domain resource ranges

In some examples, the frequency domain resource range(s) includes(include): a first frequency domain resource range with a minimum bandwidth and at least one second frequency domain resource range other than the first frequency domain resource range.

In some examples, a size of bits of the second information field is equal to a size of bits for resource assignment determined based on a bandwidth of the first frequency domain resource range.

In some examples, when the frequency domain resource assignment is type 1, a start RB of the second frequency domain resource range corresponding to a RIV included in the second information field is:

$$R {B}_{start} = 0 , K , 2 \cdot K , ... , ( {N}_{min}^{s i z e} - 1 ) \cdot K ;$$

a number of RBs that are continuously assigned is L_{RBs}=K, 2·K, . . . ,

$${N}_{min}^{s i z e} \cdot K ;$$

where,

$${N}_{min}^{size}$$

represents a bandwidth size of the first frequency domain resource range or a number of PRBs; and
K represents a ratio of a bandwidth of the second frequency domain resource range to a bandwidth of the first frequency domain resource range.

In some examples, when the frequency domain resource assignment is type 0, bits of the second information field correspond to RBGs of the second frequency domain resource range, in which
a size of a first RBG is

$$R B {G}_{0}^{s i z e} = P * K - {N}_{other , i}^{start} mod P * K ;$$

if

$$( {N}_{other , i}^{start} + {N}_{other , i}^{size} ) mod P * K > 0 ,$$

a size of a last RBG is

$${RBG}_{last}^{size} = ( {N}_{other , i}^{start} + {N}_{other , i}^{size} ) mod P * K ,$$

otherwise, the size of the last RBG is P*K, and a size of remaining RBGs is P*K;
where P represents a size of a RBG of the first frequency domain resource range, K represents a ratio of a bandwidth of the second frequency domain resource range to a bandwidth of the first frequency domain resource range;

$${N}_{other , i}^{start}$$

represents a resource starting position of the second frequency domain resource range, and

$${N}_{other , i}^{size}$$

represents a bandwidth size of the second frequency domain resource range or a number of PRBs.

It is noteworthy that the apparatus is an apparatus corresponding to the above method applied to the network side device, and all the implementations of realizing the method described above are applicable to the embodiments of the apparatus, and the same technical effects can also be achieved. The apparatus may also include a processing module 52 for processing data sent and received by the transceiver module 51.

Embodiments of the disclosure provides an apparatus for frequency domain resource assignment, which is applied to a terminal. The apparatus includes: a transceiver module, configured to receive DCI sent by a network side device, in which the DCI is used to indicate frequency domain resource assignment for physical shared channel, and the frequency domain resources of the physical shared channel are located within one or more frequency domain resource ranges.

In some examples, the DCI includes a first information field and a second information field;
the first information field is used to indicate index(s) of the one or more frequency domain resource ranges where the frequency domain resources of the physical shared channel are located in; and
the second information field is used to indicate the frequency domain resource assignment within a frequency domain resource range.

In some examples, the first information field uses a bitmap or a codepoint to indicate the index(s) of the one or more frequency domain resource ranges.

In some examples, the frequency domain resource range(s) includes(include): a first frequency domain resource range with a minimum bandwidth and at least one second frequency domain resource range other than the first frequency domain resource range.

In some examples, a size of bits of the second information field is equal to a size of bits for resource assignment determined based on a bandwidth of the first frequency domain resource range.

In some examples, when the frequency domain resource assignment is type 1, a start RB of the second frequency domain resource range corresponding to a RIV included in the second information field is:

$${RB}_{start} = 0 , K , 2 \cdot K , … , ( {N}_{min}^{size} - 1 ) \cdot K ;$$

a number of RBs that are continuously assigned is L_{RBs}=K, 2·K, . . . ,

$${N}_{min}^{size} \cdot K ;$$

in which

$${N}_{min}^{size}$$

represents a bandwidth size of the first frequency domain resource range or a number of PRBs; and
K represents a ratio of a bandwidth of the second frequency domain resource range to a bandwidth of the first frequency domain resource range.

In some examples, when the frequency domain resource assignment is type 0, bits of the second information field correspond to RBGs of the second frequency domain resource range, in which
a size of a first RBG is

$${RBG}_{0}^{size} = P * K - {N}_{other , i}^{start} mod P * K ;$$

if

$$( {N}_{other , i}^{start} + {N}_{other , i}^{size} ) mod P * K > 0 ,$$

a size of a last RBG is

$${RBG}_{last}^{size} = ( {N}_{other , i}^{start} + {N}_{other , i}^{size} ) mod P * K ,$$

otherwise, the size of the last RBG is P*K, and a size of remaining RBGs is P*K;
where P represents a size of a RBG of the first frequency domain resource range, K represents a ratio of a bandwidth of the second frequency domain resource range to a bandwidth of the first frequency domain resource range;

$${N}_{other , i}^{start}$$

represents a resource starting position of the second frequency domain resource range, and

$${N}_{other , i}^{size}$$

represents a bandwidth size of the second frequency domain resource range or a number of PRBs.

It is noteworthy that the apparatus is an apparatus corresponding to the above method applied to the terminal, and all the implementations of realizing the method described above are applicable to the embodiments of the apparatus, and the same technical effects may also be achieved.

Embodiments of the disclosure also provide a communication device, which includes a processor and a memory having a computer program stored thereon. When the computer program is executed by the processor, the methods as described above may be performed. All the implementations of method embodiments described above are applicable to this embodiment and may achieve the same technical effects.

Embodiments of the disclosure also provide a computer readable storage medium having instructions stored thereon. When the instructions are executed by a computer, the computer is caused to perform the methods as described above. All the implementations of method embodiments described above are applicable to this embodiment and may achieve the same technical effects.

With the methods, the DCI is sent to the terminal. The DCI is used to indicate the frequency domain resource assignment for physical shared channel, and frequency domain resources of the physical shared channel are located within one or more frequency domain resource ranges. Therefore, the scheduling for multiple different frequency domain resources is realized using one DCI, the throughput of carrier usage is improved, the overhead of a PDCCH is reduced, and the user experience and network performance are enhanced.

Those skilled in the art will appreciate that the units and algorithm steps of each example described in combination with the embodiments disclosed herein may be implemented by an electronic hardware, or a combination of computer software and the electronic hardware. Whether these functions are performed by hardware or software depends on the specific applications of the technical solution and the design constraints. Those skilled in the art may use different methods to implement the described functions for each specific application, but such implementations should not be considered to be beyond the scope of the disclosure.

Those skilled in the art can clearly understand that, for convenience and brevity of description, the specific working processes of the systems, devices and units described above can refer to the corresponding processes in the aforementioned method embodiments and will not be repeated here.

In embodiments according to the disclosure, it is understandable that the disclosed apparatuses and methods may be implemented in other ways. For example, embodiments of the apparatus described above are merely illustrative. For example, the classification of the units merely depends on logical functions, and there may be other classification methods in actual implementation. For example, multiple units or components may be combined or integrated into another system, or some features may be ignored or may not be executed. Moreover, the mutual coupling, direct coupling or communication connection shown or discussed may be an indirect coupling or a communication connection through some interfaces, devices or units, which may be electrical, mechanical or in other forms.

The units described as separate components may or may not be physically separated, and the components shown as units may or may not be physical units, that is, they may be located in one place or distributed over multiple network units. Some or all of the units may be selected according to actual needs to achieve the purpose of the solution of this embodiment.

In addition, each functional unit in each embodiment of the disclosure may be integrated into one processing unit, or each unit may exist physically separately, or two or more units may be integrated into one unit.

If the functions are implemented in the form of software functional units and sold or used as independent products, they can be stored in a computer-readable storage medium. Based on such understanding, the technical solution of the disclosure may essentially be embodied in the form of a software product, or the part that contributes to the related art or a part of the technical solution. The computer software product is stored in a storage medium and includes a number of instructions for enabling a computer device (which may be a personal computer, a server, or a network device, etc.) to execute all or part of the steps of the method described in each embodiment of the disclosure. The aforementioned storage medium includes: a USB flash drive, a mobile hard disk, a read only memory (ROM), a Random Access Memory (RAM), a disk or a CD-ROM, and various other mediums that can store program codes.

In addition, it should be noted that, in the apparatus and method of the disclosure, obviously, each component or step can be decomposed and/or recombined. These decompositions and/or recombinations should be regarded as equivalents of the disclosure. Moreover, the steps of executing the above series of processes can be naturally executed in a chronological order according to the described order, but they do not necessarily need to be executed in the chronological order, and some steps can be executed in parallel or independently. For those skilled in the art, it is understood that all or any steps or components of the methods and devices disclosed herein can be implemented by a hardware, a firmware, software, or a combination thereof in any computing devices (e.g., a processor, and a storage medium) or a network of the computing devices, which can be implemented by those skilled in the art using their basic programming skills after reading the description of the disclosure.

Therefore, the objects of the disclosure may also be achieved by running a program or a group of programs on any computing device. The computing device may be a known general-purpose device. Therefore, the object of the disclosure can also be achieved by merely providing a program product including a program code for implementing the method or apparatus. That is, such a program product also constitutes the disclosure, and a storage medium that stores such a program product also constitutes the disclosure. Obviously, the storage medium may be any known storage medium or any storage medium developed in the future. It should also be noted that, in the apparatus and method of the disclosure, it is apparent that each component or step can be decomposed and/or recombined. These decompositions and/or recombinations should be regarded as equivalents of the disclosure. Moreover, the steps of executing the above series of processes can be naturally executed in a chronological order according to the described order, but do not necessarily need to be executed in the chronological order. Certain steps may be performed in parallel or independently.

The above embodiments are preferred embodiments of the disclosure. It should be noted that for those skilled in the art, several improvements and modifications can be made without departing from the principles described in the disclosure. These improvements and modifications should also be regarded as the scope of protection of the disclosure.

1. A method for frequency domain resource assignment, performed by a network side device, comprising:
sending downlink control information (DCI) to a terminal, wherein the DCI is used to indicate frequency domain resource assignment for physical shared channel, and frequency domain resources of the physical shared channel are located within one or more frequency domain resource ranges.

2. The method of claim 1, wherein the DCI comprises a first information field and a second information field;
the first information field is used to indicate one or more indexes of the one or more frequency domain resource ranges where the frequency domain resources of the physical shared channel are located in; and
the second information field is used to indicate the frequency domain resource assignment within a frequency domain resource range.

3. The method of claim 2, wherein the first information field uses a bitmap or a codepoint to indicate the one or more indexes of the one or more frequency domain resource ranges.

4. The method of claim 2, wherein the one or more frequency domain resource ranges comprise: a first frequency domain resource range with a minimum bandwidth and at least one second frequency domain resource range other than the first frequency domain resource range.

5. The method of claim 2, wherein a size of bits of the second information field is equal to a size of bits for a resource assignment determined based on a bandwidth of the first frequency domain resource range.

6. The method of claim 4, wherein in response to the frequency domain resource assignment being type 1, a start resource block (RB) of the second frequency domain resource range corresponding to a resource indication value (RIV) included in the second information field is:
$${RB}_{start} = 0 , K , 2 \cdot K , … , ( {N}_{min}^{size} - 1 ) \cdot K ;$$
a number of RBs that are consecutively assigned is L_{RBs}=K, 2·K, . . . ,
$${N}_{min}^{s i z e} \cdot K ;$$
where,
$${N}_{min}^{s i z e}$$
represents a bandwidth size of the first frequency domain resource range or a number of physical resource blocks (PRBs); and
K represents a ratio of a bandwidth of the second frequency domain resource range to a bandwidth of the first frequency domain resource range.

7. The method of claim 4, wherein in response to the frequency domain resource assignment being type 0, bits of the second information field correspond to resource block groups (RBGs) of the second frequency domain resource range, wherein,
a size of a first RBG is
$$R B {G}_{0}^{s i z e} = P * K - {N}_{other , i}^{start} mod P * K ;$$
in case that
$$( {N}_{other , i}^{start} + {N}_{o t h e r , i}^{s i z e} ) mod P * K > 0 ,$$
a size of a last RBG is
$$R B {G}_{last}^{s i z e} = ( {N}_{other , i}^{start} + {N}_{o t h e r , i}^{s i z e} ) mod P * K ,$$
in case that the size of the last RBG is P*K is less than or equal to 0, and a size of remaining RBGs is P*K;
where P represents a size of a RBG of the first frequency domain resource range, K represents a ratio of a bandwidth of the second frequency domain resource range to a bandwidth of the first frequency domain resource range;
$${N}_{other , i}^{start}$$
represents a resource starting position of the second frequency domain resource range, and
$${N}_{o t h e r , i}^{s i z e}$$
represents a bandwidth size of the second frequency domain resource range or a number of PRBs.

8. A method for frequency domain resource assignment, performed by a terminal, comprising:
receiving downlink control information (DCI) sent by a network side device, wherein the DCI is used to indicate frequency domain resource assignment for physical shared channel, and frequency domain resources of the physical shared channel are located within one or more frequency domain resource ranges.

9. The method of claim 8, wherein the DCI comprises a first information field and a second information field;
the first information field is used to indicate one or more indexes of the one or more frequency domain resource ranges where the frequency domain resources of the physical shared channel are located in; and
the second information field is used to indicate the frequency domain resource assignment within a frequency domain resource range.

10. The method of claim 9, wherein the first information field uses a bitmap or a codepoint to indicate the terminal the one or more indexes of one or more scheduled frequency domain resource ranges.

11. The method of claim 9, wherein the one or more frequency domain resource ranges comprise: a first frequency domain resource range with minimum bandwidth and at least one second frequency domain resource range other than the first frequency domain resource range.

12. The method of claim 9, wherein a size of bits of the second information field is equal to a size of bits for resource assignment determined based on a bandwidth of the first frequency domain resource range.

13. The method of claim 12, wherein in response to the frequency domain resource assignment being type 1, a start resource block (RB) of the second frequency domain resource range corresponding to a resource indication value (RIV) included in the second information field is:
$$R {B}_{start} = 0 , K , 2 \cdot K , … , ( {N}_{min}^{s i z e} - 1 ) \cdot K ;$$
a number of RBs that are consecutively assigned is L_{RBs}=K, 2·K, . . . ,
$${N}_{min}^{s i z e} \cdot K ;$$
where,
$${N}_{min}^{s i z e}$$
represents a bandwidth size of the first frequency domain resource range or a number of physical resource blocks (PRBs); and
K represents a ratio of a bandwidth of the second frequency domain resource range to the bandwidth of the first frequency domain resource range.

14. The method of claim 12, wherein in response to the frequency domain resource assignment being type 0, bits of the second information field correspond to resource block groups (RBGs) of the second frequency domain resource range,
wherein a size of a first RBG is
$$R B {G}_{0}^{s i z e} = P * K - {N}_{other , i}^{start} mod P * K ;$$
in case that
$$( {N}_{other , i}^{start} + {N}_{o t h e r , i}^{s i z e} ) mod P * K > 0 ,$$
a size of a last RBG is
$$RB {G}_{last}^{s i z e} = ( {N}_{other , i}^{start} + {N}_{o t h e r , i}^{s i z e} ) mod P * K ,$$
in case that (N_{other,i}^{start}+N_{other,i}^{size}) mod P*K is less than or equal to 0, the size of the last RBG is P*K, and a size of remaining RBGs is P*K;
where P represents a size of RBG of the first frequency domain resource range, K represents a ratio of a bandwidth of the second frequency domain resource range to the bandwidth of the first frequency domain resource range;
$${N}_{other , i}^{start}$$
represents a resource starting position of the second frequency domain resource range, and
$${N}_{o t h e r , i}^{s i z e}$$
represents a bandwidth size of the second frequency domain resource range or a number of PRBs.

15-16. (canceled)

17. A communication device comprising: a processor and a memory having a computer program stored thereon, wherein when the computer program is executed by the processor, the processor is configured to:
send downlink control information (DCI) to a terminal, wherein the DCI is used to indicate frequency domain resource assignment for physical shared channel, and frequency domain resources of the physical shared channel are located within one or more frequency domain resource ranges.

18. A non-transitory computer-readable storage medium having instructions stored thereon, wherein when the instructions are executed by a computer, the method of claim 1 is performed.

19. The communication device of claim 17, wherein the DCI comprises a first information field and a second information field;
the first information field is used to indicate one or more indexes of the one or more frequency domain resource ranges where the frequency domain resources of the physical shared channel are located in; and
the second information field is used to indicate the frequency domain resource assignment within a frequency domain resource range.

20. The communication device of claim 19, wherein the first information field uses a bitmap or a codepoint to indicate the one or more indexes of the one or more frequency domain resource ranges.

21. A communication device comprising: a processor and a memory having a computer program stored thereon, wherein when the computer program is executed by the processor, the processor is configured to perform the method of claim 8.

22. A non-transitory computer-readable storage medium having instructions stored thereon, wherein when the instructions are executed by a computer, the method of claim 8 is performed.
